(19) United States
(12) Patent Application Publication
(10) Pub. No.: US 2026/0284858 A1
(43) Pub. Date: Sep. 24, 2026

(54) SCREWDRIVER STORAGE BOX WITH BIT HOLDERS HAVING ROTATING SHAFT

(71) Applicant: Keyi Technology (Guangzhou) Co., Ltd., Guangzhou (CN)

(72) Inventor: Kai OUYANG, Guangzhou (CN)

(73) Assignee: Keyi Technology (Guangzhou) Co., Ltd., Guangzhou (CN)

(21) Appl. No.: 19/674,187

(22) Filed: May 12, 2026

(30) Foreign Application Priority Data
Mar. 18, 2025 (CN) 2025204818380

(51) Int. Cl. B25H 3/00

(52) U.S. Cl. CPC B25H 3/003

(57) ABSTRACT

The present disclosure discloses a screwdriver storage box with bit holders having rotating shaft, belonging to the technical field of toolboxes, which includes a main casing, a base connected to the bottom of the main casing, the main casing is movably sleeved inside the outer cylinder, a locking switch device is set between the bottom of the base and the inner side of the bottom of the outer cylinder, and a plurality of bit holder assemblies are arranged inside the main casing. The present disclosure can rotate and arrange more bits to improve storage space, and can be easily ejected and locked with one click, which is easy to use.

### CROSS-REFERENCE TO RELATED APPLICATIONS

The application claims priority to Chinese patent application No. 2025204818380, filed on Mar. 18, 2025, the entire contents of which are incorporated herein by reference.

### TECHNICAL FIELD

The present disclosure relates to the technical field of toolboxes, in particularly a screwdriver storage box with bit holders having rotating shaft.

### BACKGROUND

As a common assembly tool, screwdriver sets are widely used in various fields such as electronic devices, furniture assembly, and mechanical maintenance. They are usually composed of a handle and multiple specifications of screwdriver bits, aiming to provide users with convenient disassembly and assembly solutions. However, the traditional screwdriver set has the following defects in design.
1. The traditional tool box has a single design for the bit storage area, with each bit placed in a limited space in an unordered manner, resulting in a limited number of bits that can be accommodated and low space utilization;
2. The traditional tool boxes have a larger overall volume due to storage requirements, making them inconvenient to carry;
3. The existing tool boxes use a split casing, but during assembly, the casing needs to be inserted first, rotated to screw into the base, and a clicking sound must be heard to indicate that the tightening is in place. Multiple processes and operations in different directions are required to lock and tighten the casing and base, which is very complicated and affects the user experience.

### SUMMARY

The present disclosure provides a screwdriver storage box with bit holders having rotating shaft, aiming to solve the obvious shortcomings of traditional screwdriver storage boxes in terms of spatial layout, storage capacity, and convenient locking operation.

In order to achieve the above objective, the present disclosure provides a screwdriver storage box with bit holders having rotating shaft, which includes a main casing, a base, an outer cylinder, bit holder assemblies, and a locking switch device, wherein a bottom of the main casing is connected with the base, the main casing is movably sleeved inside the outer cylinder, an elastic lockable connection is formed between a bottom of the base and an inner side of a bottom of the outer cylinder by setting a locking switch device, a plurality of the bit holder assemblies that are stacked and capable of being rotated are arranged inside the main casing, and a damping assembly is provided between the base and a bottom of one of the plurality of the bit holder assemblies.

Preferably, each bit holder assembly includes a bit seat, a flange plate, and a cylindrical magnet; a lower part of the bit seat is engaged with an upper part of the flange plate, and a lower part of the flange plate is engaged with an upper part of the adjacent bit seat; the bit seat is provided with the cylindrical magnet inside, and the cylindrical magnet is located between the bit seat and the flange plate; a plurality of screwdriver bit sockets are arranged in a circular shape on an outer side of a middle of the bit seat, and the screwdriver bit sockets correspond to the position of the cylindrical magnet.

Preferably, a eccentric position of a top of the main casing is provided with a first positioning pillar, the first positioning pillar is used to connect with the bit seat in one of the bit holder assemblies, and a first bearing is installed between the bit seat and the first positioning pillar; the eccentric position of the base is provided with a second positioning pillar, a circular plate is provided on the base, an upper part of the circular plate is connected with the lower part of the bit seat in a snap-fit, a second bearing is provided at a lower part of the circular plate, the second bearing is rotatably connected with the second positioning pillar, both sides of the base located at the second positioning pillar are provided with mounting holes, and the damping assembles are arranged inside the mounting holes.

Preferably, each damping assembly includes a cylinder, a damping spring, and a ball, the mounting hole is fitted with a cylinder, the damping spring is provided inside the cylinder, a plurality of spherical recesses are form on a bottom surface of the circular plate in an annular array, and the movable balls are provided between the spherical recesses and the damping springs to allow the bit holder assemblies to rotate with damping.

Preferably, a eccentric position of the top of the main casing is provided with a first positioning pillar, the first positioning pillar is used to connect with the bit seat in one of the bit holder assemblies, and a first bearing is installed between the bit seat and the first positioning pillar; the eccentric position of the base is provided with a second positioning pillar, second positioning pillar is used to connect with the flange plate in one of the bit holder assemblies, and a second bearing is installed between the flange plate and the second positioning pillar.

Preferably, one side of the main casing is connected with a screwdriver bit casing, and an other side of the main casing is connected with an electric screwdriver casing, and the screwdriver bit casing is fixedly connected with the electric screwdriver casing.

Preferably, the outer side of the screwdriver bit casing is provided with a plurality of short-strip screwdriver bit holders, and an inner side of the screwdriver bit casing is provided with a plurality of square magnets corresponding to the short-strip screwdriver bit holders, and the outer side of the electric screwdriver casing is provided with a long-strip electric screwdriver holder.

Preferably, the locking switch device includes an inverted hook, a mounting slot, and a locking component. The center of the base is provided with a plurality of the inverted hooks, and the bottom of the outer cylinder is connected with a plurality of the mounting slots corresponding to the inverted hooks. The mounting slots are fastened with the locking components, and the locking components are used for locking connection with the inverted hooks.

Preferably, the locking component includes an assembly square shell, a movable part, clamp clips, a spring, and a metal guide rail frame; the assembly square shell is fixedly installed in the mounting slot, and the movable part capable of being moved up and down is arranged inside the assembly square shell; the spring is arranged between the movable part and the assembly square shell; a side of the movable part is provided with a guiding slot, and the metal guide rail frame is connected between the guiding slot and the assembly square shell; two sides of a top of the movable part are integrally formed with the clamp clips, and an inner side of the connection between the clamp clips and the movable part is provided with an avoidance groove, so that the clamp clips are capable of being retracted inward to lock the inverted hooks.

Preferably, a compression spring is fixedly installed at the bottom of the outer cylinder, and the top of the compression spring is against on the base to support the main casing upward.

Preferably, the bottom of the base is provided with an annular groove, and a silicone pad is installed inside the annular groove.

The advantageous effects of present disclosure compared to existing technology are:

The present disclosure provides a screwdriver storage box with bit holders having rotating shaft. On the basis of the traditional bit storage function, by setting the bit holder assembly, it can store more bit tools, making rotation and retrieval of damping elements convenient, improving storage space, and reducing overall volume. Using a locking switch device, simply pressing the top of the main casing once along the axial direction of the outer cylinder enables ejection and locking, making it easy to use and providing a better experience.

To clarify the structural features and efficacy of the present disclosure, a detailed illustration of the present disclosure will be provided below in conjunction with the accompanying drawings and specific embodiments.

### BRIEF DESCRIPTION OF DRAWINGS

FIG. 1 is a schematic diagram of the three-dimensional assembly structure of the present disclosure;

FIG. 2 is a schematic diagram of the structure of the outer cylinder in the present disclosure;

FIG. 3 is a schematic diagram of the exploded structure of the present disclosure;

FIG. 4 is a schematic diagram of the cross-sectional structure of the bit holder assembly in the present disclosure;

FIG. 5 is a schematic diagram of the three-dimensional structure of the bit holder assembly in the present disclosure;

FIG. 6 is a schematic diagram of the exploded structure of the bit holder assembly in the present disclosure;

FIG. 7 is a schematic diagram of the structure of the present disclosure in open state;

FIG. 8 is a schematic diagram of the structure of the locking switch device in the present disclosure;

FIG. 9 is a schematic diagram of the structure of the locking component in the present disclosure;

FIG. 10 is a schematic diagram of the exploded structure of the locking component in the present disclosure;

FIG. 11 is a schematic diagram of the cross-sectional structure of a base, a circular plate, and a damping assembly in the present disclosure;

FIG. 12 is a schematic diagram of the exploded structure of FIG. 11.

Reference Numbers in the Drawings

1. main casing; 2. base; 201. silicone pad; 202. mounting hole; 203. annular groove; outer cylinder; 301. mounting slot; 302. compression spring; 4. bit holder assembly; 401. bit seat; 402. flange plate; 403. cylindrical magnet; 404, screwdriver bit socket; 5. first positioning pillar; 501. first bearing; 6. second positioning pillar; 601. second bearing; 7. screwdriver bit casing; 701. short-strip screwdriver bit holder; 702. square magnet; 8. electric screwdriver casing; 801. long-strip electric screwdriver holder; 9. locking component; 901. assembly square shell; 902, movable part; 903, clamp clip; 904. spring; 905. metal guide rail frame; 906, guiding slot; 907. avoidance groove; 10. inverted hook; 11. damping assembly; 1101. cylinder; 1102. damping spring; 1103. ball; 12. circular plate; 1201. spherical recess.

### DETAILED DESCRIPTION OF THE EMBODIMENTS

Unless otherwise defined, all technical and scientific terms used in this article have the same meanings as those commonly understood by those skilled in the art of the present application. The terms used in the specification of the application in this article are only for the purpose of describing specific embodiments and are not intended to limit the present application. The terms “including” and “having” as well as any variations thereof in the specification and claims of this application and the accompanying drawings are intended to cover non exclusive inclusion. The terms “first”, “second”, etc. used in the specification and claims of this application or in the accompanying drawings are intended to distinguish different objects and not to describe a specific order.

Referring to “embodiments” in this article means that specific features, structures, or characteristics described in conjunction with the embodiments may be included in at least one embodiment of the present application. The phrase appearing in various positions in the article does not necessarily refer to the same embodiment, nor is it an independent or alternative embodiment that is mutually exclusive with other embodiments. The skilled person in the art can explicitly and implicitly understand that the embodiments described in this article can be combined with other embodiments.

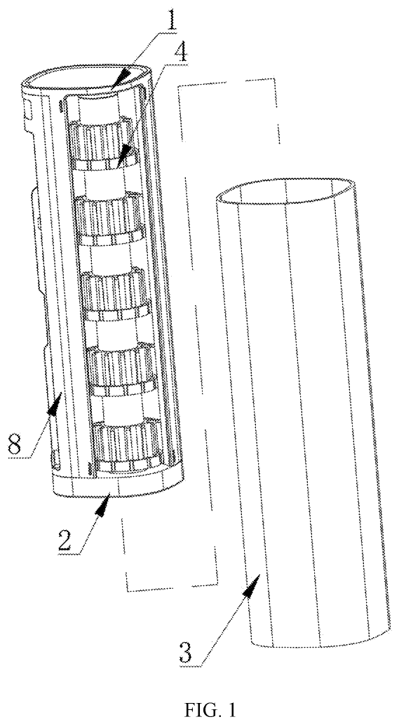

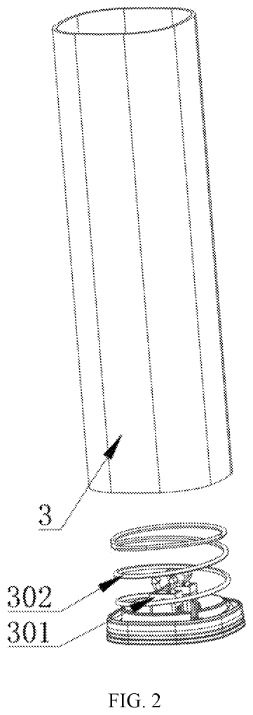

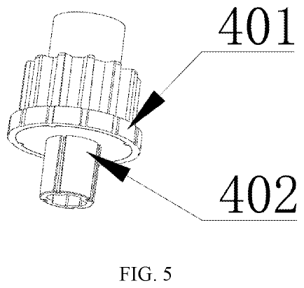

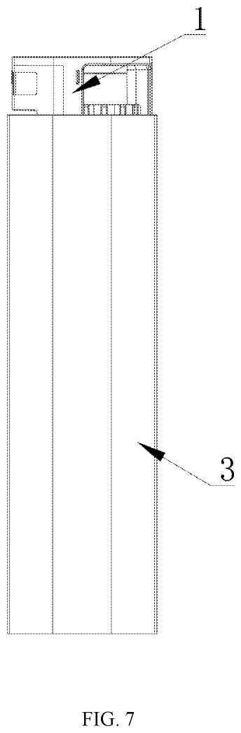

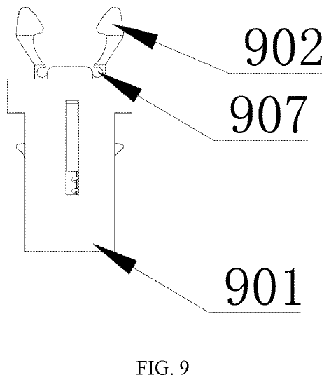

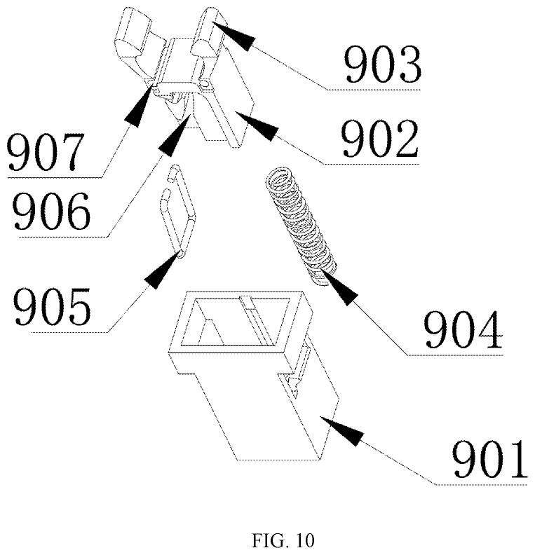

In order to achieve the above objective, the present disclosure provides a screwdriver storage box with bit holders having rotating shaft, referring to FIG. 1-FIG. 12, which includes a main casing 1, a base 2, an outer cylinder 3, bit holder assemblies 4, and a locking switch device, wherein the bottom of the main casing 1 is connected with the base 2, the main casing 1 is movably sleeved inside the outer cylinder 3, an elastic lockable connection is formed between the bottom of the base 1 and the inner side of the bottom of the outer cylinder 3 by setting the locking switch device, and a plurality of the bit holder assemblies 4 that are stacked and capable of being rotated are arranged inside the main casing 1. A damping assemblies 11 are provided between the base 2 and a bottom of one of the plurality of the bit holder assemblies 4.

In this embodiment, based on the problems of insufficient storage structure, inconvenient to retrieve and use and troublesome operation of existing screwdriver bits, multiple screwdriver bit holder assemblies 4 are stacked and arranged into a rotatable cylindrical body. The number of screwdriver bit holder assemblies 4 is arranged according to the tool usage requirements, such as 5 stacked, so as to store more screwdriver bit tools. Through stacked placement, the screwdriver bit tools can also be placed on the corresponding layer according to the specifications and models of the screwdriver bits. By setting a locking switch device, it is possible to press the main casing 1 with one click to directly open the screwdriver bit for retrieve and use, and press the main casing 1 again with one click to directly store and lock screwdriver bit tools. The operation process is further simplified.

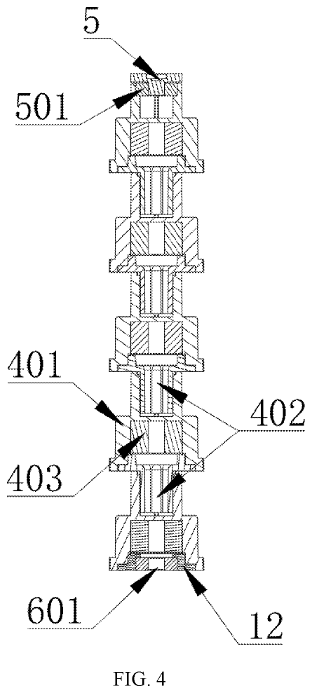

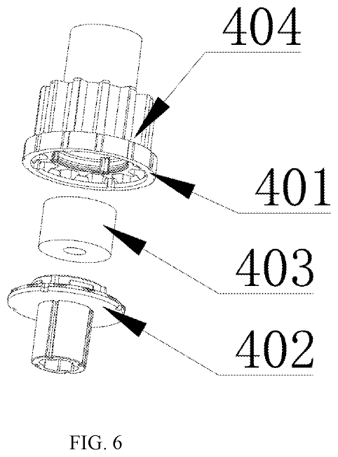

Specifically, referring to FIG. 4-FIG. 6, the bit holder assembly 4 includes a bit seat 401, a flange plate 402, and a cylindrical magnet 403. The lower part of the bit seat 401 is engaged with the upper part of the flange plate 402, and the lower part of the flange plate 402 is engaged with the upper part of the adjacent bit seat 401. The bit seat 401 is provided with the cylindrical magnet 403 inside, and the cylindrical magnet 403 is located between the bit seat 401 and the flange plate 402. A plurality of screwdriver bit sockets 404 are arranged in a circular shape on the outer side of the middle of the bit seat 401, and the screwdriver bit sockets 404 correspond to the position of the cylindrical magnet 403. In this way, the upper and lower adjacent bit seats 401 and flange plates 402 can be connected together via a sleeve coupling mechanism. For example, as shown in FIG. 6, the lower part of the bit seats 401 is provided with inward concave groove positions, and the upper part of the flange plate 402 is provided with multiple outward convex clamp positions, which are fitted together to form a concave-convex connection. The upper part of the bit seat 401 is provided with an inner cylinder, and the inner wall of the inner cylinder is provided with a plurality of assembly convex strip position, the lower part of the flange plate 402 is set as a convex cylinder, the outer wall of the convex cylinder is equipped with a plurality of concave strip positions, and the two are interlocked to form a convex-concave connection, so that both the upper and lower parts of the bit seat 401 can form a stacked combination with the adjacent upper and lower positions of the flange plate 402, forming a rotating shaft connection.

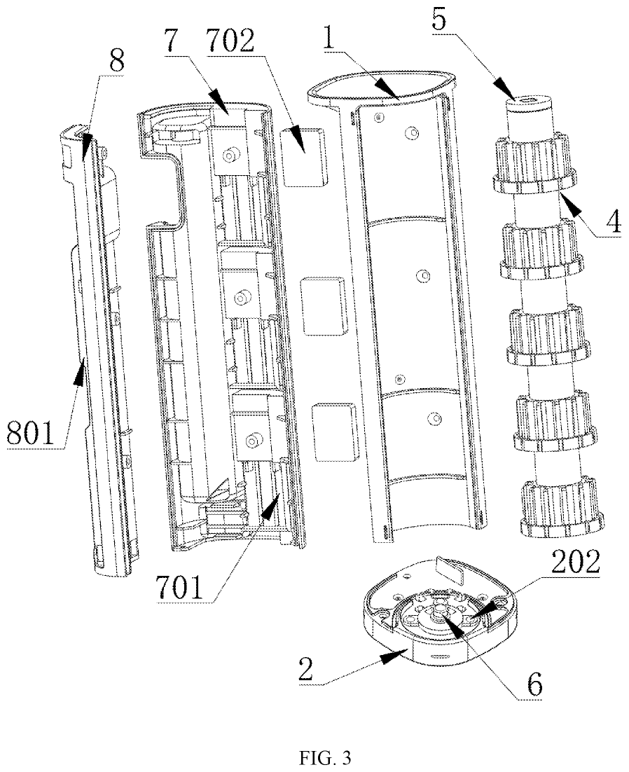

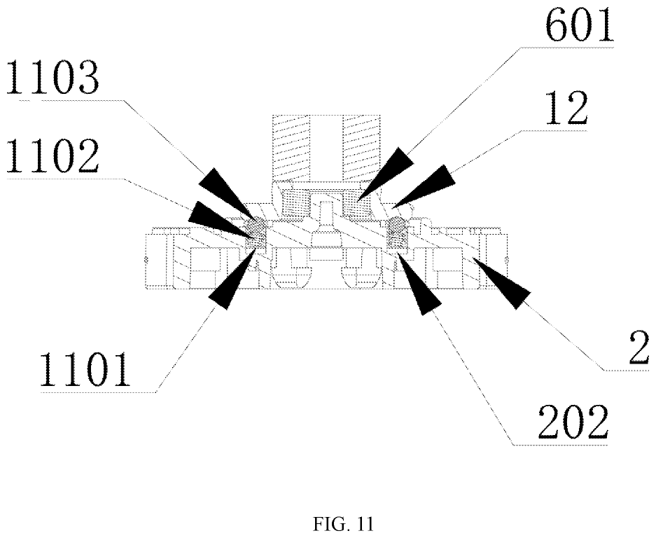

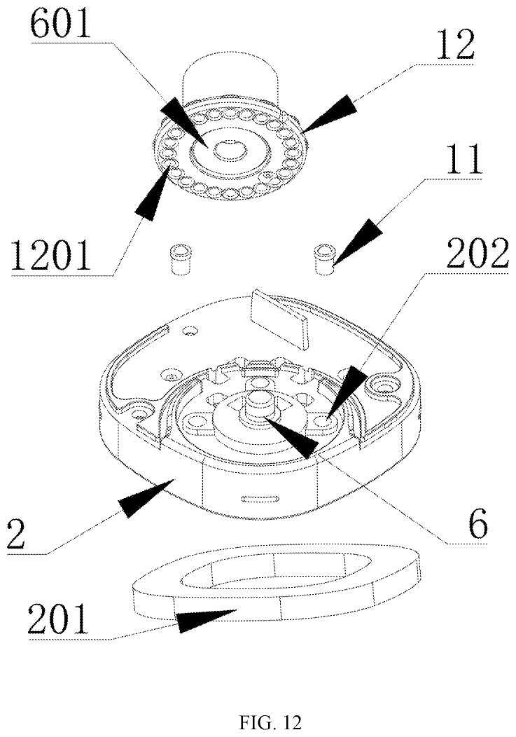

In this embodiment, referring to FIG. 3, FIG. 11 and FIG. 12, the eccentric position of the top of the main casing 1 is provided with a first positioning pillar 5, the first positioning pillar 5 is used to connect with the bit seat 401 in one of the bit holder assemblies 4, and a first bearing 501 is installed between the bit seat 401 and the first positioning pillar 5. The eccentric position of the base 2 is provided with a second positioning pillar 6, and a circular plate 12 is provided on the base 2. The upper part of the circular plate 12 is connected with the lower part of the bit seat 401 in a snap-fit, a second bearing 601 is provided at the lower part of the circular plate 12, and the second bearing 601 is rotatably connected with the second positioning pillar 6. Both sides of the base 2 located at the second positioning pillar 6 are provided with mounting holes 202, and the damping assembles 11 are arranged inside the mounting holes 202. In this way, by arranging the bit holder assembly 4 at the eccentric position of the base 2, the space design is greatly utilized, and the other side of the eccentric position can be reserved for other purposes, such as storing electric screwdrivers or other types of screwdriver bits, greatly improving the spatial layout.

Further, referring FIG. 11, each damping assembly 11 includes a cylinder 1101, a damping spring 1102, and a ball 1103. The mounting hole 202 is fitted with the cylinder 1101, the damping spring 1102 is provided inside the cylinder 1101, a plurality of spherical recesses 1201 are form on the bottom surface of the circular plate 12 in an annular array, and the movable balls 1103 are provided between the spherical recesses 1201 and the damping springs 1102 to allow the bit holder assemblies 4 to rotate with damping.

In an alternative embodiment, the number of spherical recesses 1201 in the annular array on the bottom surface of the circular plate 12 can correspond to the number of screwdriver bit sockets 404 on the bit seat 401, so that each time a screwdriver needs to be taken or replaced, it only needs to be rotated to the corresponding position, instead of the traditional undamped setting that causes the whole stacked bit holder assemblies 4 to rotate for several times under the action of inertia, which is inconvenient for users to put and take the corresponding screwdriver model. By using the damping spring 1102 to push the ball 1103 to fall into the spherical recess 1201, it can gently rotate to jump to the next screwdriver model under the external force.

Further, in the other direction of the eccentric position of the base 2, one side of the main casing 1 is connected with a screwdriver bit casing 7, and the other side of the main casing 1 is connected with an electric screwdriver casing 8. The screwdriver bit casing 7 is fixedly connected with the electric screwdriver casing 8, and the bottom of both forms a fixed clamp position connection with the preset position of the end face of the base 2.

Specifically, the outer side of the screwdriver bit casing 7 is provided with a plurality of short-strip screwdriver bit holders 701, and an inner side of the screwdriver bit casing 7 is provided with a plurality of square magnets 702 corresponding to the short-strip screwdriver bit holders 701. When the strip-shaped screwdriver bit is vertically placed in the short strip-shaped screwdriver bit holder 701, it is magnetically attracted and fastened by the square magnet 702, which is not easy to fall off, and the strip-shaped screwdriver bit can be taken out by applying external force when in use. The outer side of the electric screwdriver casing 8 is provided with a long-strip electric screwdriver holder 801 for placing electric screwdrivers. In this way, both the screwdriver bits and the electric screwdriver are effectively stored, and the structural design is more reasonable.

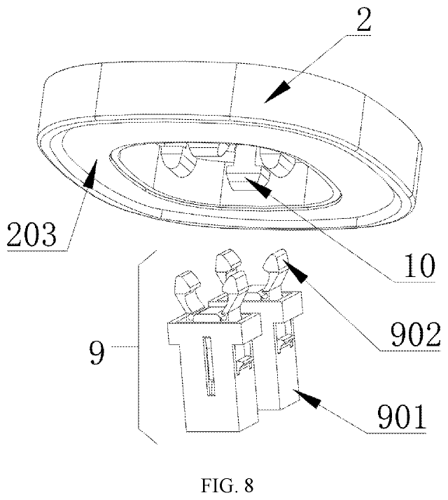

In this embodiment, referring to FIG. 8-FIG. 10, the locking switch device includes an inverted hook 10, a mounting slot 301, a locking component 9, and a compression spring. The center of the base 2 is provided with a plurality of the inverted hooks 10, and the bottom of the outer cylinder 3 is connected with a plurality of the mounting slots 301 corresponding to the inverted hooks 10. The mounting slots 301 are fastened with the locking components 9, and the locking components 9 are used for locking connection with the inverted hooks 10.

Specifically. the locking component 9 includes an assembly square shell 901, a movable part 902, clamp clips 903, a spring 904, and a metal guide rail frame 905. The assembly square shell 901 is fixedly installed in the mounting slot 301, and the movable part 902 capable of being moved up and down is arranged inside the assembly square shell 901. The spring 904 is arranged between the movable part 902 and the assembly square shell 901. The side of the movable part 902 is provided with a guiding slot 906, and the metal guide rail frame 905 is connected between the guiding slot 906 and the assembly square shell 901. Two sides of the top of the movable part 902 are integrally formed with the clamp clips 903, and the inner side of the connection between the clamp clips 903 and the movable part 902 is provided with an avoidance groove 907, so that the clamp clips 903 are capable of being retracted inward to lock the inverted hooks 10. The compression spring 302 is fixedly installed at the bottom of the outer cylinder 3, and the top of the compression spring 302 is against on the base 2 to support the main casing 1 upward. The bottom of the base 2 is provided with an annular groove, and a silicone pad 201 is installed inside the annular groove.

In this embodiment, the user presses down the top surface of the main casing 1 with force, then the inverted hook 10 pushes the movable part 902 downwards, at this time, the compression spring 302 is compressed, the spring 904 is compressed, and the clamp clip 903 is stored in the mounting slot 301 as the movable part 902 moves downwards. The clamp clip 903 grasps the inverted hook 10 tightly, the top of the metal guide rail frame 905 is located at the upper position of the guiding slot 906 to form a locking, and the main casing 1 is fitted into the outer cylinder 3 and locked. The user presses down again on the top surface of the main casing 1 with force. With the cooperation of the spring 904, the top of the metal guide rail frame 905 and the upper part of the guiding slot 906 are separated from the locking position. Under the action of the elasticity of the spring 904 and the compression spring 302 supporting the base 2 upwards, the movable part 902 is pushed out by the spring 904 and disengages from the mounting slot 301. At this time, the clamp clip 903 expands its arms under the action of the avoidance groove 907, and forms a separated state with the inverted hook 10. With the continued upward push of the compression spring 302, the top surface of the main casing 1 exposes from the top of the outer cylinder 3, making it easy for users to pull out the main casing 1 and quickly obtain the screwdriver bit and electric screwdriver.

In summary, the present disclosure provides a a screwdriver storage box with bit holders having rotating shaft. Based on the traditional bit storage function, by setting the bit holder assembly 4, the present disclosure can store more bit tools, making rotation and retrieval of damping elements convenient, improving storage space, and reducing overall volume. Using a locking switch device, simply pressing the top of the main casing 1 once along the axial direction of the outer cylinder 3 enables ejection and locking, making it easy to use and providing a better user experience.

The above description of the technical principle of the present disclosure in combination with specific embodiments is only the preferred embodiment of the present disclosure. The scope of present disclosure is not limited to the above embodiments, and any technical solution under the concept of present disclosure belongs to the scope of present disclosure. The other specific embodiments of the present disclosure that the skilled person in the art do not need to exert creative labor to associate with will all fall within the scope of the present disclosure.

What is claimed is:

1. A screwdriver storage box with bit holders having rotating shaft, comprising a main casing, a base, an outer cylinder, bit holder assemblies, and a locking switch device, wherein a bottom of the main casing is connected with the base, the main casing is movably sleeved inside the outer cylinder, an elastic lockable connection is formed between a bottom of the base and an inner side of a bottom of the outer cylinder by setting the locking switch device, a plurality of the bit holder assemblies that are stacked and capable of being rotated are arranged inside the main casing, and damping assembles are provided between the base and a bottom of one of the plurality of the bit holder assemblies.

2. The screwdriver storage box with bit holders having rotating shaft according to claim 1, wherein each bit holder assembly comprises a bit seat, a flange plate, and a cylindrical magnet; a lower part of the bit seat is engaged with an upper part of the flange plate, and a lower part of the flange plate is engaged with an upper part of the adjacent bit seat; the bit seat is provided with the cylindrical magnet inside, and the cylindrical magnet is located between the bit seat and the flange plate; a plurality of screwdriver bit sockets are arranged in a circular shape on an outer side of a middle of the bit seat, and the screwdriver bit sockets correspond to a position of the cylindrical magnet.

3. The screwdriver storage box with bit holders having rotating shaft according to claim 2, wherein a eccentric position of a top of the main casing is provided with a first positioning pillar, the first positioning pillar is used to connect with the bit seat in one of the bit holder assemblies, and a first bearing is installed between the bit seat and the first positioning pillar; the eccentric position of the base is provided with a second positioning pillar, a circular plate is provided on the base, an upper part of the circular plate is connected with the lower part of the bit seat in a snap-fit, a second bearing is provided at a lower part of the circular plate, the second bearing is rotatably connected with the second positioning pillar, both sides of the base located at the second positioning pillar are provided with mounting holes, and the damping assembles are arranged inside the mounting holes.

4. The screwdriver storage box with bit holders having rotating shaft according to claim 3, wherein each damping assembly comprises a cylinder, a damping spring, and a ball, the mounting hole is fitted with the cylinder, the damping spring is provided inside the cylinder, a plurality of spherical recesses are form on a bottom surface of the circular plate in an annular array, and the movable balls are provided between the spherical recesses and the damping springs to allow the bit holder assemblies to rotate with damping.

5. The screwdriver storage box with bit holders having rotating shaft according to claim 3, wherein one side of the main casing is connected with a screwdriver bit casing, and another side of the main casing is connected with an electric screwdriver casing, and the screwdriver bit casing is fixedly connected with the electric screwdriver casing.

6. The screwdriver storage box with bit holders having rotating shaft according to claim 5, wherein an outer side of the screwdriver bit casing is provided with a plurality of short-strip screwdriver bit holders, and an inner side of the screwdriver bit casing is provided with a plurality of square magnets corresponding to the short-strip screwdriver bit holders, and the outer side of the electric screwdriver casing is provided with a long-strip electric screwdriver holder.

7. The screwdriver storage box with bit holders having rotating shaft according to claim 1, wherein the locking switch device comprises an inverted hook, a mounting slot, and a locking component; a center of the base is provided with a plurality of the inverted hooks, and the bottom of the outer cylinder is connected with a plurality of the mounting slots corresponding to the inverted hooks; the mounting slots are fastened with the locking components, and the locking components are used for locking connection with the inverted hooks.

8. The screwdriver storage box with bit holders having rotating shaft according to claim 7, wherein the locking component comprises an assembly square shell, a movable part, clamp clips, a spring, and a metal guide rail frame; the assembly square shell is fixedly installed in the mounting slot, and the movable part capable of being moved up and down is arranged inside the assembly square shell; the spring is arranged between the movable part and the assembly square shell; a side of the movable part is provided with a guiding slot, and the metal guide rail frame is connected between the guiding slot and the assembly square shell; two sides of a top of the movable part are integrally formed with the clamp clips, and an inner side of the connection between the clamp clips and the movable part is provided with an avoidance groove, so that the clamp clips are capable of being retracted inward to lock the inverted hooks.

9. The screwdriver storage box with bit holders having rotating shaft according to claim 7, wherein a compression spring is fixedly installed at the bottom of the outer cylinder, and a top of the compression spring is against on the base to support the main casing upward.

10. The screwdriver storage box with bit holders having rotating shaft according to claim 1, wherein the bottom of the base is provided with an annular groove, and a silicone pad is installed inside the annular groove.
